(19) United States
(12) Patent Application Publication
(10) Pub. No.: US 2004/0011881 A1
(43) Pub. Date: Jan. 22, 2004

(54) Method and apparatus for abating storm strength

(76) Inventor: Fernando Morales, Reston, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/458,976

(22) Filed: Jun. 11, 2003

Related U.S. Application Data
(63) Continuation-in-part of application No. 09/669,478, filed on Sep. 25, 2000, now abandoned.
(60) Provisional application No. 60/161,235, filed on Oct. 22, 1999.

(51) Int. Cl. A01G 15/00

(52) U.S. Cl. 239/2.1

(57) ABSTRACT

The invention reduces the pressure differential between the eye and the body of a storm thereby degrading a storm. A pipeline with sealed ends is placed in a violent storm, with one end at the high-pressure body and one end at the low-pressure eye. Controllable valves open the pipeline once the low and high-pressure ends are above water level. Air from the high-pressure end flows through the pipeline to reach the eye of the storm thereby establishing equilibrium. Alternate embodiments decrease pressure differential by positioning storage tanks of compressed gasses to inject air or other gas into the eye or low-pressure region of the storm.

### RELATED APPLICATIONS

The present invention is a continuation-in-part of application Ser. No. 09/669,478, filed Sep. 25, 2000, which claims the benefit of provisional application serial No. 60/161,235, filed Oct. 22, 1999.

### BACKGROUND OF THE INVENTION

The present invention relates to storm abatement. More specifically, this invention relates to an apparatus and method of causing a decay in the wind-speeds of hurricane-type storms that have an “eye.”

Bad weather can often escalate into catastrophic events. The evening news brings reports of the devastation and death brought on by violent, hurricane-type storms. People are forced to evacuate their homes in order to escape the devastating effects. Statistics gathered by the National Oceanic and Atmospheric Administration estimate the current population in hurricane-vulnerable areas of the U.S. to be near 139 million people.

Violent, hurricane-type storms arise from certain atmospheric conditions. Due to the Coriolis Effect, air tends to circulate in a counterclockwise direction in the northern hemisphere and a clockwise direction in the southern hemisphere. When a warm front pushes northward and a cold front pulls southward about a low-pressure area, the storm begins to form. As the air spirals, air pressure increases. The high-pressure air moves inward toward the lower-pressure area. In the low-pressure area, air currents rise to reach the lower atmospheric pressure found at the higher altitude. The rising air expands, causing a decrease in surrounding air temperature and an increase in relative humidity. Large bands of clouds and rain build in the swirling air to form a storm wall.

Violent storms include tropical storms, cyclones, anticyclones and hurricanes. These violent storms are characterized by differences in temperature and pressure between the main body and the eye, or center, of the storm. Violent storms are mostly characterized by a low-pressure eye and a high-pressure body. However, anticyclones are characterized by a high-pressure eye and a low-pressure body.

Currently, there is no way to stop or abate the course of a violent storm once it begins to develop. Only a natural change in weather patterns can change the course of the violent storm. People are completely reliant on the arbitrary course of nature, and have no way of stopping the imminent harm of the storm. Thus, it is desirable to have a method of decaying a storm in order to prevent the widespread death and destruction such storms cause.

### BRIEF SUMMARY OF THE INVENTION

It is an object of the present invention to provide a man-made method of abating the impact of a violent storm.

It is an object of the present invention to decrease the pressure differential between the eye and the body of a violent storm.

It is an object of the present invention to provide an abatement means that decreases the pressure differential between the eye and the body of a violent storm.

It is yet another object of the present invention to provide a method of providing an abatement means to decrease the pressure differential of storms.

According to the present invention, decreasing the pressure differential between the eye and the body of a storm can degrade a violent storm by equalizing the pressure differential between the eye and the body. Because the air pressure is different in each area, the air attempts to reach equilibrium. As a result, if a large pipe is connected between the high and low pressure regions, air flows through the pipe, with high-pressure air moving toward the low-pressure air. The pressure differential between the eye and the body decreases. In turn, the low-pressure air ceases to rise. As a result, relative humidity is decreased, and vapor generation and vapor condensation decrease. As the vapor condensation decreases, the temperature in the eye of the storm decreases. As the temperature decreases, vapor generation decreases even more. As a result, the pressure differential between the eye and the body of the storm increasingly lowers, thus decaying the storm. The pressure differential in a violent storm is approximately 20% to 30%, whereas a non-violent rainstorm will have a pressure differential of approximately 5%. These values are approximate, as the study of storm characteristics is quite difficult due to their violent nature.

Storm pressure differential (SPD) can be decreased in several ways. First, a pipeline or series of pipelines can be installed in either a fixed or moving manner so as to extend from the eye of the storm to the body of the storm. Air pressure will seek to equalize, thereby decaying the storm.

SPD can also be equalized, when the eye of the storm is a low-pressure eye, by the release of a gas such as compressed air, liquid oxygen, or ozone, into the eye of a storm. Gas is stored and released via storage tanks of such gas that are pre-positioned or moved into place where the gas is released.

Other features and benefits for the invention will be more clearly understood with reference to the specification and the accompanying drawings, which follow.

### BRIEF DESCRIPTION OF THE DRAWINGS

FIG. 1 illustrates an abatement apparatus positioned in a violent storm.

FIG. 2 illustrates the abatement apparatus.

FIG. 3 illustrates the installation of an abatement apparatus.

FIG. 4 illustrates an embodiment of the abatement apparatus.

FIG. 5 illustrates the effect of a pipeline on an idealized storm model.

FIG. 6 illustrates a comparison of pipe radius to wind speed reduction.

FIG. 7 illustrates the effect of multiple pipelines of reduced radius on wind speed reduction.

FIG. 8 illustrates the effect of varied pipe length on wind velocity reduction.

FIG. 9 illustrates a model of the present invention's effect on a known hurricane.

FIG. 10 illustrates a model of the present invention's effect on a known hurricane.

FIG. 11 illustrates an air tank embodiment of the abatement apparatus.

FIG. 12 illustrates a pre-positioned air tank embodiment of the weather control apparatus.

### DETAILED DESCRIPTION OF THE INVENTION

Violent storms have been tracked for many years, producing a large amount of historical storm track data. These storms are presently tracked by satellites and other weather sensors. Powerful weather-modeling computer programs are also used to predict the probable path of these violent storms. Using this information to determine probable storm track areas, the present invention can be employed for a sufficient period of time at a distance sufficiently far from populated areas to abate violent storms that threaten those areas.

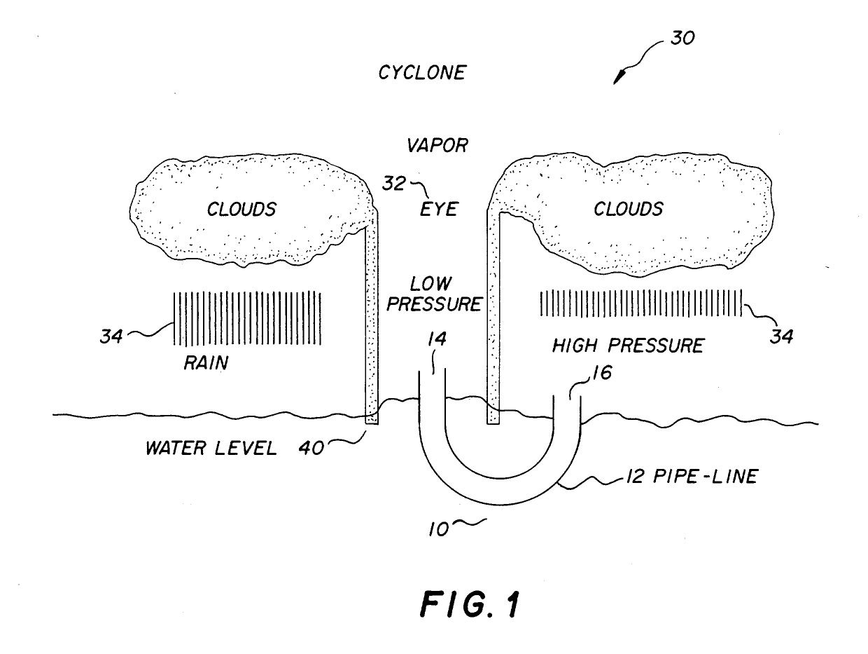

Referring to FIG. 1, the position of an abatement apparatus 10 within a violent storm 30 is illustrated. The violent storm 30 occurs above the water level 40 of an ocean. When the pipeline 12 is in place, the flotation means 15 (not shown in FIG. 1) holds the pipeline 12 afloat near the water level 40. The low-pressure end 14 is placed in the eye 32 of the storm. The high-pressure end 16 is placed in the body 34 of the storm. Both the low-pressure 14 and high-pressure 16 ends extend upwards from the water level 40 and into the atmosphere.

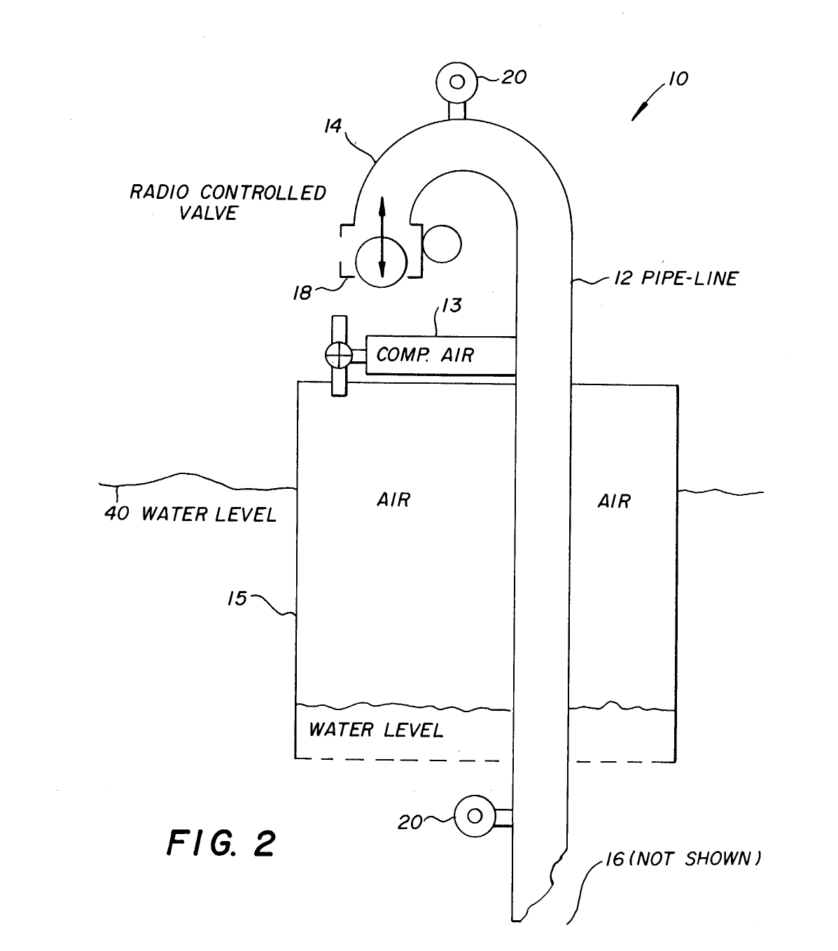

Referring to FIGS. 1 and 2, once the pipeline 12 is placed as described in FIG. 2, the control means 18 are activated to open. Once the pipeline is open, High-pressure air from the body 34 of the storm attempts to reach equilibrium with the low-pressure area and pushes through the pipeline 12 toward the eye 32. The airflow places high-pressure air within the eye 32. In turn, air within the eye 32 does not tend to rise. Resulting vapor generation from the rising air slows. As vapor generation decreases, so does vapor condensation. As the vapor condensation decreases, the temperature in the eye of the storm decreases. As the temperature decreases, vapor generation decreases even more. As a result, the pressure differential between the eye and the body of the storm decreases, thus decaying the storm.

Referring to FIG. 2, the abatement apparatus 10 is illustrated. The abatement apparatus 10 comprises a pipeline 12, with a low-pressure end 14 and a high-pressure end 16. Both the low pressure 14 and high-pressure 16 ends are bent in the shape of a hook. The purpose of the hook shape is to shield the opening from rainwater and waves while the low-pressure 14 and high-pressure 16 ends are above water level 40. While a hook shape is used in this embodiment, it will be appreciated by those skilled in the art that various configurations of the ends 14, 16 may be used as well as adding shields, valves, or the like, in order to keep water from entering the pipeline 12. The pipeline 12 is a conduit that has a hollow center throughout, and is made of material that may be submerged in seawater. The length of the pipeline 12 must be long enough to ensure the low-pressure 14 and high-pressure 16 ends are properly placed, as discussed below. The diameter of the pipeline 12 dictates the time needed to bring the pressure differential of the storm to zero. The time required to reach a zero pressure differential is inversely proportional to the diameter of the pipeline 12.

Both the low-pressure end 14 and the high-pressure end 16 of the pipeline 12 terminate with a control means 18. The control means 18 keeps water out of the pipeline 12, but can be opened once the low-pressure 14 and high-pressure 16 ends are placed above water level 40. It will be appreciated by those skilled in the art that a wide variety of mechanisms can be used as the control means 18. In the embodiment shown in FIG. 2, a ball valve reacting on buoyancy can be used. When the valve is submerged, water presses against the valve and seals the pipeline 12. Once the low-pressure 14 and high-pressure 16 ends are above water level 40 the weight of the ball drops with gravity and opens the pipeline 12 to air. In another embodiment (not shown), radio-controlled valves comprise the control means 18. Fastening means 20 are attached along the outer surface of the pipeline 12. A flotation means 15 is secured about the pipeline 12. The flotation means 15 is a substantially enclosed structure with the open side facing toward the bottom of the ocean. A compressed air tank 13 is connected to the flotation means 15 and is controllably opened. When the compressed air tank 13 is opened, air displaces the water inside the structure. The buoyancy of the air causes the pipeline 12 to rise toward the surface.

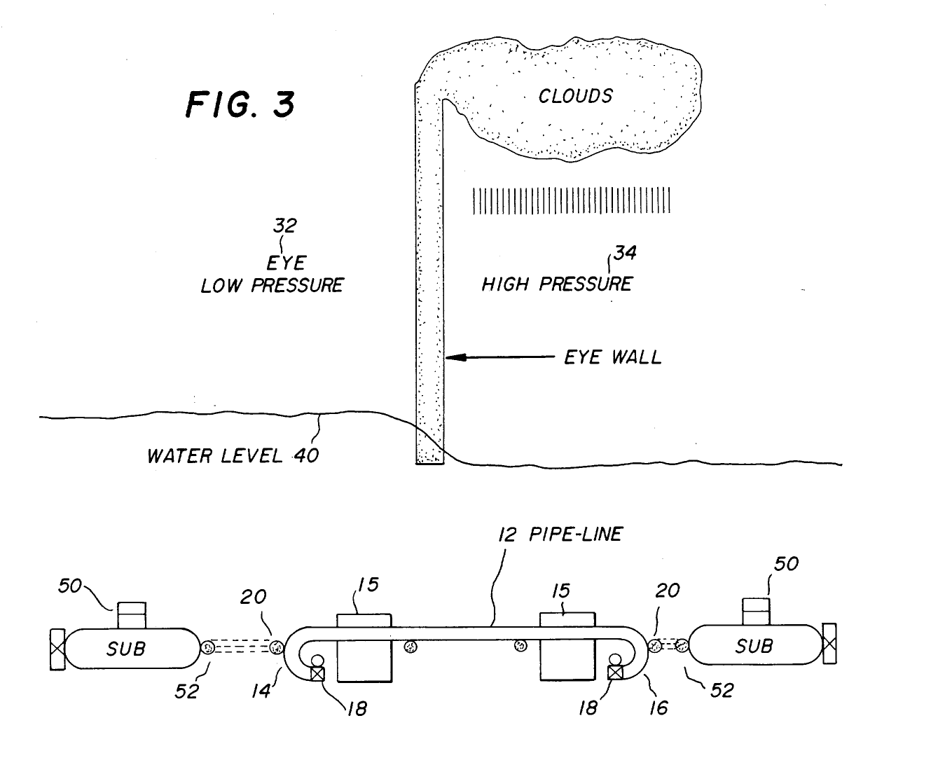

Referring to FIG. 3, a method of installing the pipeline 12 is illustrated. An underwater vessel 50 is fitted with an attachment means 52. The attachment means 52 cooperates with the fastening means 20 on the pipeline 12. An underwater vessel 50 connects to the fastening means 20 via the attachment means 52 at each end of the pipeline 12. In the preferred embodiment, two underwater vessels 50 are used to properly position the low-pressure 14 and high-pressure 16 ends of the pipeline 12. Without limitation, an underwater vessel 50, may be a submarine. However, one skilled in the art will appreciate that many types of underwater vehicles may be used. Once the pipeline 12 is below the storm at the proper position, compressed air tank 13 is opened. The abatement apparatus 10 floats to the water level 40. Once the abatement apparatus 10 floats to the water level 40, the control means 18 is released to allow airflow through the pipeline 12 as previously described. The underwater vessels 50 keep the pipeline 12 positioned as the storm moves.

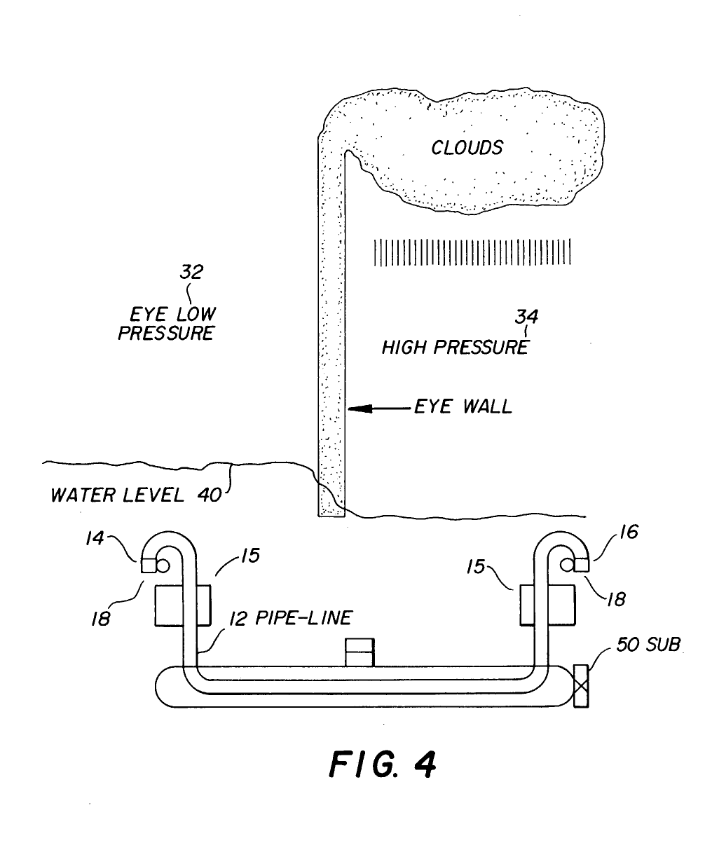

Referring to FIG. 4, another embodiment of the present invention is illustrated. Here, a pipeline 12 is incorporated within an underwater vessel 50. As previously described, the underwater vessel 50 keeps the pipeline 12 properly positioned relative to the storm. Underwater vessels 50 may be remotely controlled or have a crew present.

One embodiment of the invention (not shown) comprises the abatement apparatus 10 including a series of smaller diameter pipelines 12. The smaller pipelines 12 are used. As described above, the diameter of a pipeline 12 affects the time needed for the storm to decay. Thus the sum total of the cross-sectional surface area of the pipelines determines rate of decay.

While a single pipeline is discussed above, a series of pipelines may comprise one or more pipelines put in place by multiple groups of vessels. Additionally, multiple groups of bundled pipelines can be used. Indeed, given the size of storms and the size of an eye of, for example a hurricane, the present invention may work equally as well with multiple pipelines in place.

Varying Pipeline Dimensions

Several computerized test models were run to determine the effect a pipeline's dimensions have on rate of storm decay. General pipe flow characteristics are based on the following assumptions. First, the Reynolds Number (Re) was assumed to be large enough that airflow is fully turbulent. Air was treated as an ideal gas, with decompression and adiabatic cooling offset by dissipated turbulence kinetic energy. For a circular pipe:

Re=(2UR)/v

Where v is kinematic viscosity. Kinematic viscosity for tropical air at sea levels is a constant of 1.5×10⁻⁵ m²/s.

Pipe flow velocity (Uₘ²) was calculated based on Bernoulli's equation with no frictional loss.

Uₘ²=2R_{d}Tₛ In (p_{L}/p_{c})

However, air entering the pipe causes a turbulent boundary layer inside the edge of the pipe, distorting the flow profile. Flow velocity was generally calculated as:

U²=Uₘ² (2R/L) (1/f)

The friction factor (f) was calculated assuming that the inside of the pipe is smooth and the radius of the pipe is sufficiently large to near the smooth pipe limit. Then, the friction factor becomes 1/f=0.813 ln (Re f)−0.2631−233/(Re f)^{0.90}.

The preceding equations were iteratively solved to determine pipe flow velocity (U) for various pipe dimensions.

The pipe dimension models were based on performance of the present invention of known storm and hurricane characteristics. The model for storm intensity used was developed by Professor Kerry A. Emanuel, 1995, Massachusetts Institute of Technology. The model assumes a thin atmospheric boundary layer at the sea surface. The mass stream function of the boundary layer accounts for mass source of magnitude (M) at the storm center. Mass sink is taken at a radius L from the storm center.

M=N R²ρₐU

Note that N is the number of pipes, consistent with a single or multiple pipeline embodiment as disclosed herein. Additionally, though specific enthalpy differs between a point on radius L and the storm center, it is assumed that entropy is conserved in the pipe flow.

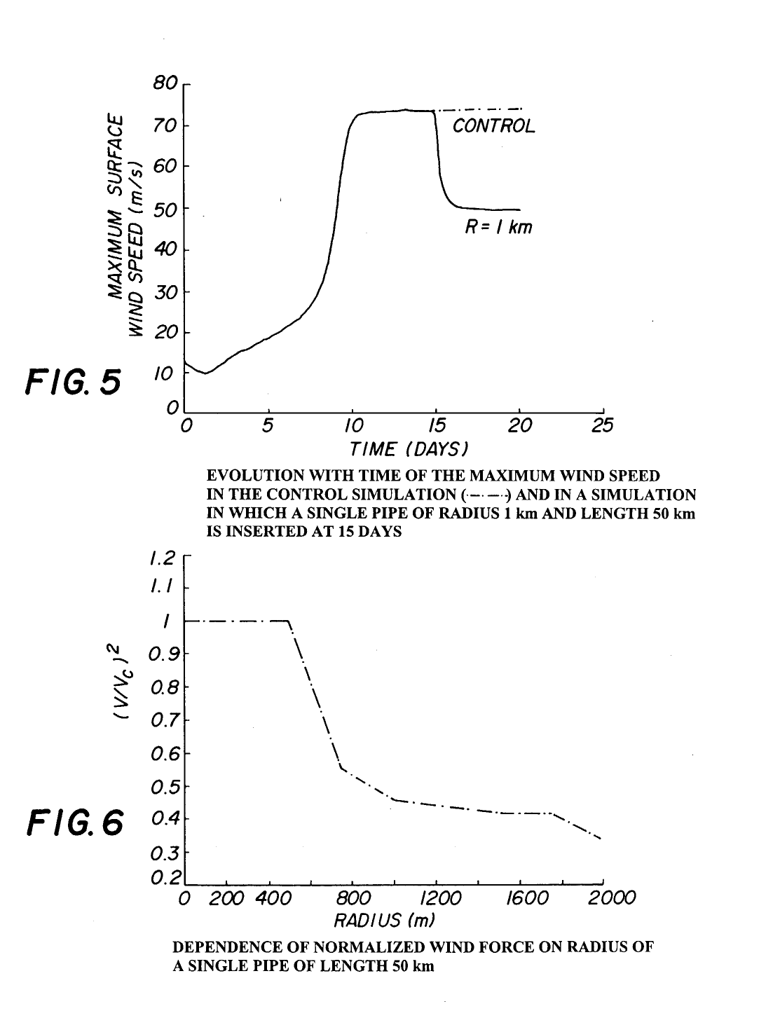

Hurricane simulations assumed a steady thermodynamic environment with a fixed sea surface temperature. Wind speeds were set to a maximum of 74 m/s. The model is run with the storm in progress, then randomly inserting the present invention into the storm at some point near or at steady state. The storm typically achieves steady state about fifteen days into the simulation. The results of the storm simulations follow. The tests illustrated in FIGS. 5 through 7 used a constant pipe length of 50 kilometers. The eye of a typical hurricane has a radius of approximately 40 kilometers. The pipe length of 50 kilometers was chosen to sufficiently span the eye wall so as to demonstrate a worst case senario. In actual use, it is not anticipated that pipes will need to be nearly this long, but rather only long enough to span the higher and lower pressure regions of the storm, which can be relatively close for storms with well developed eye-walls.

Referring to FIG. 5, the simulation results when inserting a single pipe embodiment into an idealized storm are illustrated. The pipe was given a radius of one kilometer. The pipe was inserted into the storm after fifteen days. At the time, the maximum wind speed of the storm was 74 m/s. As shown in FIG. 5, the pipeline reduced the maximum wind speed to approximately 50 m/s. Moreover, the reduction occurred over a period of less than twenty-four hours. This simulation shows a 32% reduction of wind velocity from the hurricane. This significant reduction of the hurricane's wind velocity in turn greatly reduces the damage a hurricane does when reaching land.

Referring to FIG. 6, the comparison of pipe radius to wind speed reduction is illustrated. In this test, the radius of the pipe was varied, but pipe length remained constant. The effect of the pipeline on a storm was tested for a radius of up to two thousand meters. Results showed that a radius of five hundred (500) meters up to one thousand (1,000) meters significantly reduced wind speed. The change of the pipeline radius affects mass flow. Once the pipeline radius extends beyond one thousand meters, the mass flow rate allows the eye of the storm to expand, and the pressure differential inside the eye is not significantly affected. These results further show a highly effective single pipe embodiment would have approximately a seven hundred fifty meter radium for a pipe length of fifty kilometers. Of course, this massive pipe radius is required by the massive frictional losses over a 50 kilometer length. Shorter pipes will not suffer these losses and will not require such a large radius.

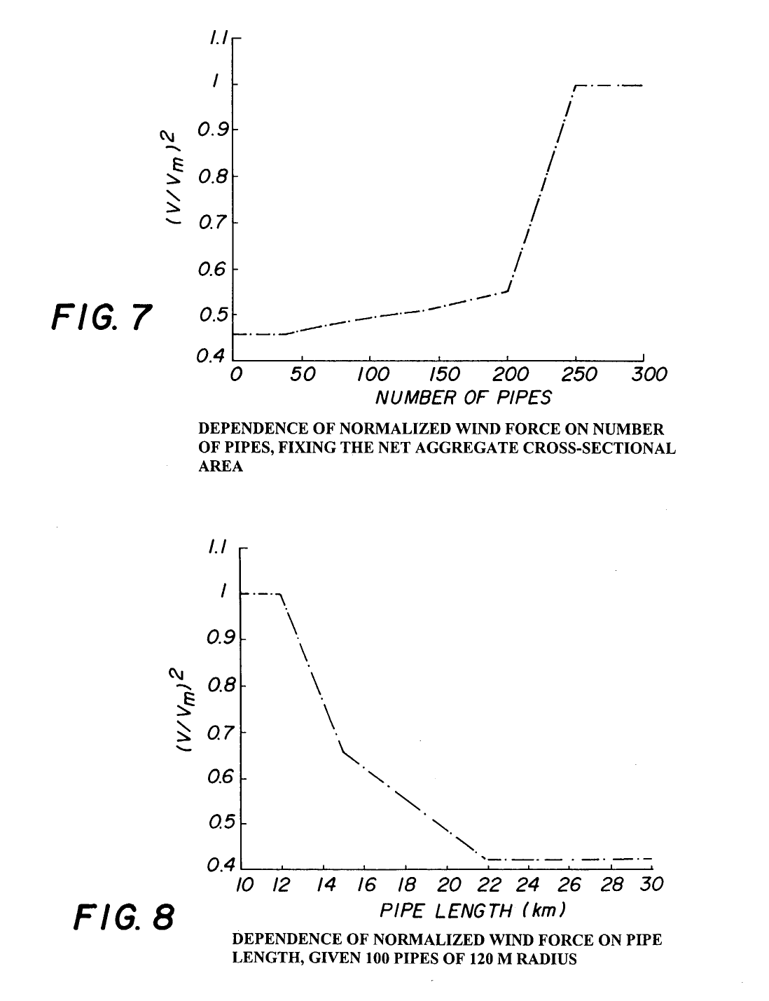

Referring to FIG. 7, the effects of using multiple pipelines of smaller radius is illustrated. The test was performed with a number of small pipelines with an aggregate, cross sectional area remaining constant at one thousand meters. As shown, the smallest radius using multiple pipelines that continues to significantly decrease wind velocity requires 200 pipes each with a radius of approximately seventy meters. Notably though, the effects of friction on velocity of air through the pipeline increase as the number of pipelines increases.

Referring to FIG. 8, the effect of varied pipe length on wind velocity reduction is illustrated. The pipeline model used in this test is a multiple pipeline model. The model used 100 pipes each having a radius of 120 meters. The pipeline was significantly effective at reducing wind velocity for lengths of 10 to 22 kilometers. Beyond 22 kilometers, increased length did not degrade the storm any further. It is important to note that this length supposes a smaller storm. It is expected that longer pipe length will be required for storms having larger eye walls.

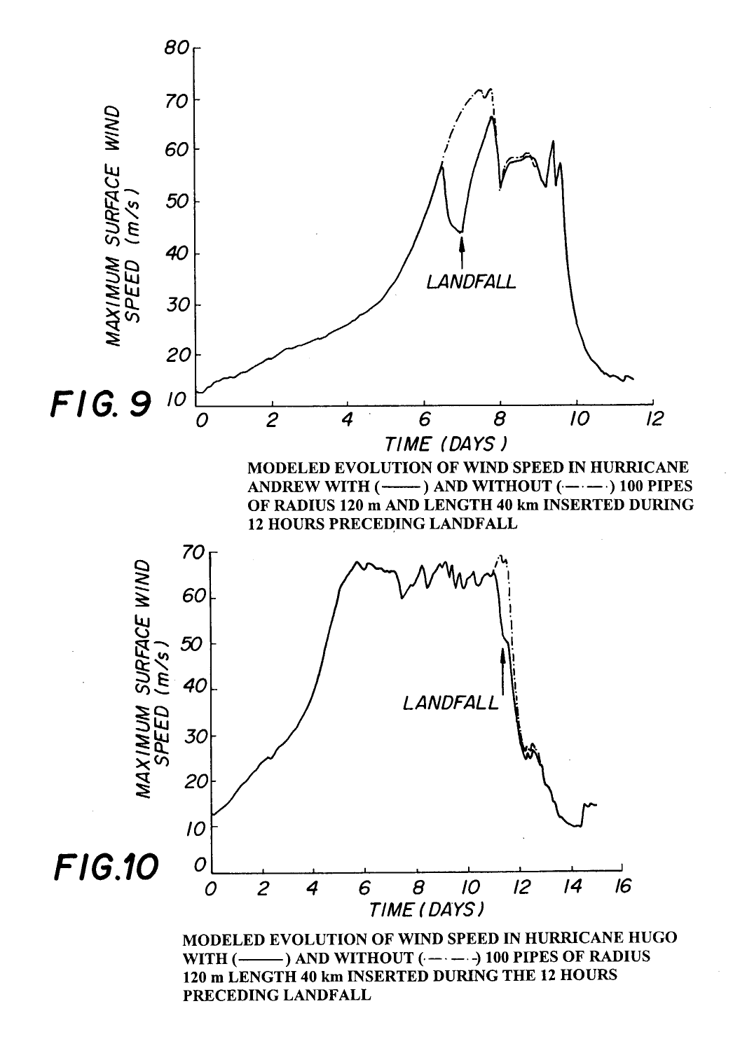

FIG. 9 illustrates a model of inserting a pipeline of the present invention into Hurricane Andrew. Hurricane Andrew occurred in 1992 in the area of southern Florida. This hurricane caused significant harm to the property and inhabitants of Florida. Hurricane Andrew achieved wind speeds of over 70 m/s. The model inserts a pipeline of the present invention having 100 pipes, each with a radius of 120 meters, and a length of 40 kilometers into the hurricane at day six. The pipeline was kept in the center of the storm for twelve hours preceding landfall. As shown in FIG. 9, this pipeline is predicted to reduce maximum wind speed from approximately 70 m/s to approximately 42 m/s. This result would have meant a 40% reduction of wind speed at landfall. Such a reduction in wind speed significantly reduces the amount of damage caused by the hurricane.

FIG. 10 illustrates a model of inserting a pipeline of the present invention into Hurricane Hugo. Similar to the test run for Hurricane Andrew, the pipeline model used was 100 pipes, each with a radius of 120 meters, and a length of 40 kilometers into the hurricane at day six. The pipeline was kept in the center of the storm for twelve hours preceding landfall. This model shows the pipeline reducing wind speed from 68 m/s to 48 m/s. This result would have caused a 30% reduction of wind speed at landfall. Such a reduction in wind speed significantly reduces the amount of damage caused by the hurricane.

Air Tank Embodiment

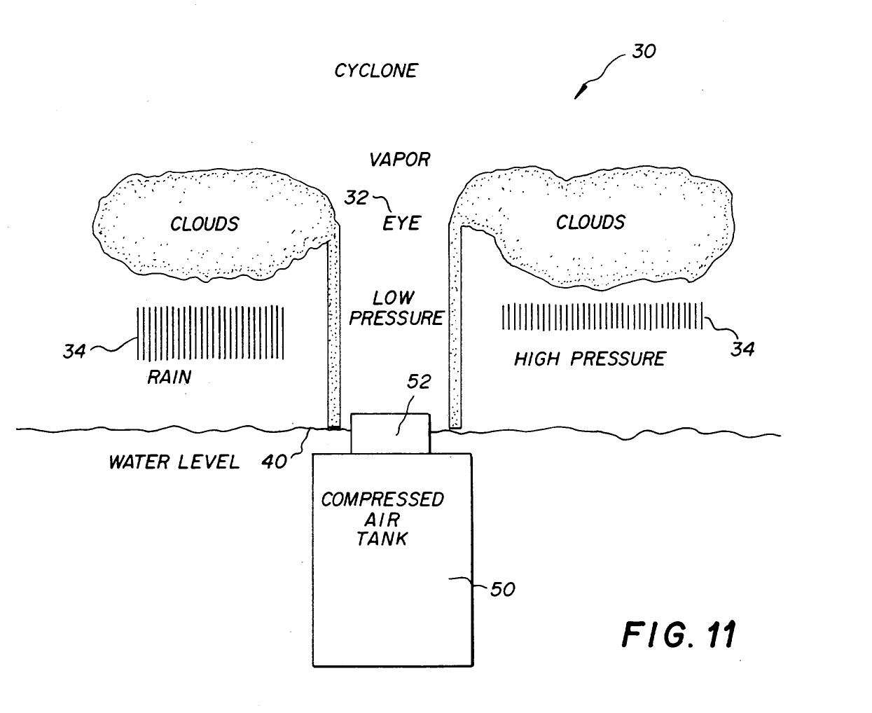

Referring to FIG. 11 an embodiment of the present invention is illustrated. A compressed air tank 50 is used to change the pressure within the eye 32 of the hurricane. The compressed air tank 50 floats just below the water level 40. A release means, such as an opening 52 extends above the water level 40. The compressed air tank 50 is positioned with the release means 52 in the eye 32 of the hurricane. When the tank is properly positioned, the compressed air is released into the eye 32 of the hurricane.

The air mixture contained in the compressed air tank 50 is further changed to vary how the air pressure in the eye 32 of the hurricane is increased. Pure oxygen(O₂) or ozone (O₃) can be used as the compressed air mixture. Both oxygen forms have a heavy molecular weight. The pressure differential decreases at a faster rate. Cooling and vapor generation further decrease, and the storm decays. Although the present invention has been described with respect to violent storms that have a low-pressure eye and a high-pressure body, it will be appreciated by those skilled in the art that the weather control apparatus will be equally as effective when used to neutralize an anticyclone. An anticyclone has a high-pressure eye and a low-pressure body, and circulates clockwise in the northern hemisphere and counterclockwise in the southern hemisphere. In addition, the pressure of ozone in the eye of the storm blocks ultra violet rays from providing further heating in the eye of the storm. The prevention of heating minimizes vapor formation within the eye, and further calms the storm.

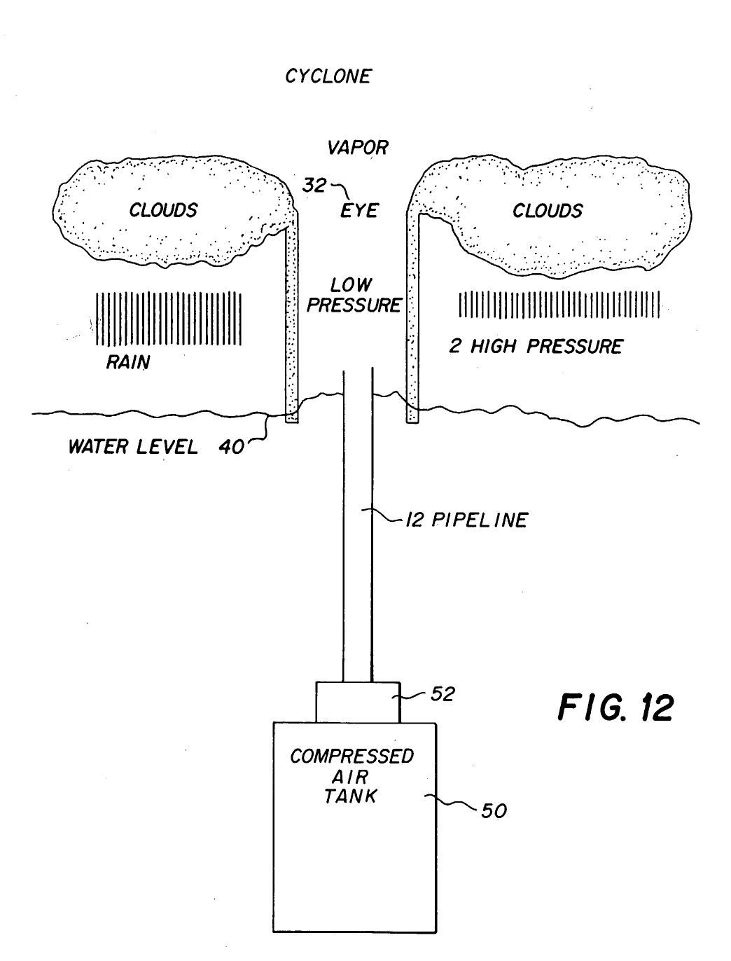

Referring to FIG. 12, a pre-positioned air tank embodiment is illustrated. In this embodiment, the compressed air tank 50 is held in a fixed position on the ocean floor. The release means 52 of the tank can be coupled with a pipeline 12. As previously described, the air tank 52 may contain air, pure oxygen, or ozone. The pipeline 12 is constructed to extend from the tank 50 above water level 40. When the pipeline 12 is properly positioned, the release means 52 is activated. High-pressure gas stored in the air tank 50 is released into the eye 32 of the storm.

To protect a coastal city, the present invention can be employed by pre-positioned gas storage or building a fixed set of pipes, possibly flooded and opened with ballast-type gas-displacement of water to push the water out through check valves. Some portions of these pipes could be even be overland to ease construction. Pre-positioned tanks and pipes could be activated by radio-control, pressure control, or a combination thereof. Historical storm-path data could be used to determine an area that the eye of a storm heading for the coastal city would likely pass over sufficiently prior to landfall (i.e., during the 12 hours prior to landfall). A plurality of tanks or pipe ends could then be located within this area.

Coastal populations can also be protected with movable abatement means. However, pipes of sufficient length and diameter may be difficult to move and submarine vessels may be expensive to build. In view of this, it is also possible to provide compressed air tanks on a plurality of unmanned barges that can be towed and anchored in position after a probable damaging storm track has been determined.

Although the invention has been shown and described with respect to exemplary embodiments thereof, various other changes, omissions and additions in form and detail thereof may be made therein without departing from the spirit and scope of the invention. For example, although compressed air tanks and conventional release means for the air tanks have been disclosed, the present invention could also be practiced with liquefied gases that are released by a vaporizer or quickly vaporized by explosively rupturing the liquefied gas storage tanks. The use of liquefied gas requires added refrigeration expenses, but provides benefits due to decreased storage volume and the cooling effect on the ocean and atmosphere caused by the absorbed heat of vaporization.

What is claimed is:

1. A method of abating storms by decreasing storm pressure differential, comprising:
determining a probable storm track;
positioning at least one means for decreasing storm pressure differential on said storm track at a distance sufficiently remote from landfall; and
activating said at least one means for decreasing storm pressure differential when within a low pressure region of a violent storm.

2. The method of claim 1, further comprising:
determining said probable storm track using historical violent storm data to determine a probable storm track area; and
pre-positioning a plurality of means for decreasing storm pressure differential within said probable storm track area.

3. The method of claim 1, further comprising:
determining a probable storm track of a particular storm; and
moving a plurality of means for decreasing storm pressure differential to an area along said storm track at a distance sufficiently remote from landfall.

4. The method of claim 1, further comprising selecting said at least one means for decreasing storm pressure differential from the group consisting of pipes, compressed gas tanks, and liquefied gas tanks.

5. The method of claim 1, further comprising activating said at least one means for decreasing storm pressure differential by remote signaling.

6. The method of claim 1, further comprising activating said at least one means for decreasing storm pressure differential by sensing a pressure indicative of said low pressure region of said violent storm.

7. A system for abating storms by decreasing storm pressure differential, comprising:
at least one means for decreasing storm pressure differential, said at least one means for decreasing storm pressure differential being located on a storm track at a distance sufficiently remote from landfall; and
means for activating said at least one means for decreasing storm pressure differential when within a low pressure region of a violent storm.

8. The system of claim 7, further comprising:
a plurality of means for decreasing storm pressure differential pre-positioned in a probable storm track area as determined by historical violent storm data.

9. The system of claim 7, further comprising:
means for determining a probable storm track of a particular storm; and
means for moving a plurality of means for decreasing storm pressure differential to an area along said storm track at a distance sufficiently remote from landfall.

10. The system of claim 7, further comprising said at least one means for decreasing storm pressure differential being selected from the group consisting of pipes, compressed gas tanks, and liquefied gas tanks.

11. The system of claim 7, wherein said means for activating said at least one means for decreasing storm pressure differential is a radio-controlled release valve.

12. The system of claim 7, wherein said means for activating said at least one means for decreasing storm pressure differential is a pressure-controlled release valve.
